(19) United States
(12) Patent Application Publication
(10) Pub. No.: US 2015/0135315 A1
(43) Pub. Date: May 14, 2015

(54) SYSTEM AND METHOD FOR BOTNET DETECTION

(71) Applicant: National University of Computer and Emerging Sciences, Islamabad (PK)

(72) Inventors: Syed Affan Ahmed, Islamabad (PK); Ayesha Binte Ashfaq, Islamabad (PK); Naurin Rasheed Ramay, Melbourne (AU); Syed Ali Khayam, Islamabad (PK); Zainab Abaid, Rawalpindi (PK); Muhammad Umar Aslam, Jhelum (PK)

(73) Assignee: National University of Computer and Emerging Sciences, Islamabad (PK)

(21) Appl. No.: 14/076,270

(22) Filed: Nov. 11, 2013

(51) Int. Cl. H04L 29/06

(52) U.S. Cl. CPC H04L 63/1441
USPC 726/23

(57) ABSTRACT

A method, system, and apparatus configured to use a Bayesian inference model for detecting botnets in a network is disclosed. The system and apparatus may include an event generator and a controller. The event generator may detect at least one event in received data, and provide information associated with the at least one event. The controller may receive the information associated with the at least one event, determine, using a Bayesian learning process, a Bayesian network model based on the information associated with the at least one event, and determine whether at least one host associated with the received data is a bot.

### BACKGROUND

1. Field

Exemplary embodiments of the disclosure relate to a system and method to detect botnet threats.

2. Discussion of the Background

A bot or botnet may refer to one or more programs that communicate over a network, such as the Internet, to execute instructions provided by the one or more programs. As use of the Internet continues to grow, the number of illegal or adverse botnets used to compromise data and user security and to launch virtual attacks on the Internet has increased. The attacks may include, for example, distributed denial of service attacks, adware, spyware, malware, and click fraud.

To counter the growing botnet threats, anomaly detection systems and bot detection systems have been used to detect botnet threats. However, conventional anomaly detection systems suffer from high false positive rates, and conventional bot detection systems disadvantageously use rigid rules and heuristic models in an ad-hoc manner to detect botnet threats. Accordingly, an improved technique for botnet detection is needed.

The above information disclosed in this Background section is only for enhancement of understanding of the background of the disclosed subject matter and therefore may contain information that does not form the prior art that is already known to a person of ordinary skill in the art.

### SUMMARY

Exemplary embodiments of the disclosed subject matter provide a method, system, and apparatus configured to use a Bayesian inference model for detecting botnets in a network.

Additional features of the disclosure will be set forth in the description which follows, and in part will be apparent from the description, or may be learned by practice of the disclosed subject matter.

Exemplary embodiments of the disclosed subject matter disclose an apparatus including an event generator and a controller. The event generator is configured to detect at least one event in received data, and to provide information associated with the at least one event. The controller is configured to receive the information associated with the at least one event, to determine, using a Bayesian learning process, a Bayesian network model based on the information associated with the at least one event, and to determine whether at least one host associated with the received data corresponds to a bot.

Exemplary embodiments of the disclosed subject matter disclose a method for botnet detection. The method includes receiving data from at least one host, detecting at least one event in the received data, providing information associated with the at least one event, determining, using a Bayesian learning process, a Bayesian network model based on the information associated with the at least one event, and determining whether the at least one host associated corresponds to a bot.

Exemplary embodiments of the disclosed subject matter disclose one or more non-transitory computer-readable storage media having stored thereon a computer program that, when executed by one or more processors, causes the one or more processors to perform acts. The acts include receiving data from at least one host, detecting at least one event in the received data, providing information associated with the at least one event, determining, using a Bayesian learning process, a Bayesian network model based on the information associated with the at least one event, and determining whether the at least one host associated corresponds to a bot.

It is to be understood that both the foregoing general description and the following detailed description are exemplary and explanatory and are intended to provide further explanation of the disclosed subject matter as claimed.

### BRIEF DESCRIPTION OF THE DRAWINGS

The accompanying drawings, which are included to provide a further understanding of the disclosed subject matter and are incorporated in and constitute a part of this specification, illustrate exemplary embodiments of the present disclosure, and together with the description serve to explain the principles of the present disclosure.

FIG. 1 is a diagram illustrating a communications system according to exemplary embodiments of the disclosed subject matter.

FIG. 2 is a block diagram of a botnet detector according to exemplary embodiments of the disclosed subject matter.

FIG. 3 is a diagram of a training mode of a botnet detector according to exemplary embodiments of the disclosed subject matter.

FIG. 4 is a diagram of an evaluation mode of a botnet detector according to exemplary embodiments of the disclosed subject matter.

FIG. 5 is a diagram of the action mode of a botnet detector according to exemplary embodiments of the disclosed subject matter.

### DETAILED DESCRIPTION OF THE ILLUSTRATED EMBODIMENTS

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements.

It will be understood that when an element or layer is referred to as being “on”, “connected to”, or “coupled to” another element or layer, it can be directly on, connected, or coupled to the other element or layer or intervening elements or layers may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing exemplary embodiments only and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the disclosed subject matter are described herein with reference to cross-section illustrations that are schematic illustrations of idealized embodiments (and intermediate structures) of the disclosed subject matter. As such, variations from the shapes of the illustrations as a result, for example, of manufacturing techniques and/or tolerances, are to be expected. Thus, exemplary embodiments of the disclosed subject matter should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the disclosed subject matter will be described in detail with reference to the accompanying drawings.

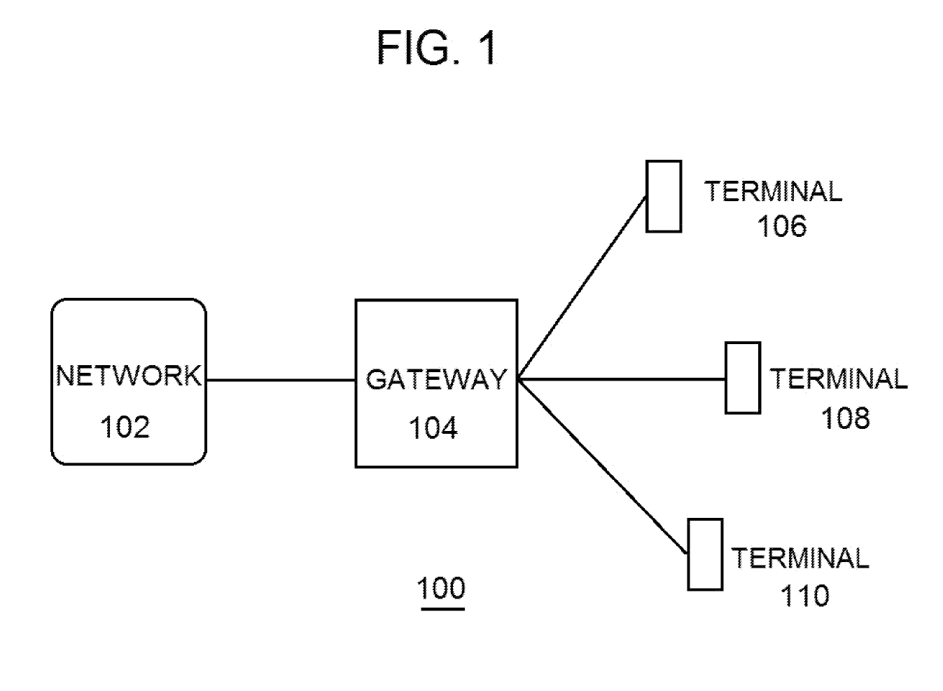

FIG. 1 is a diagram illustrating a communications system 100 according to exemplary embodiments of the disclosed subject matter. The communications system 100 may include a network 102, a gateway 104, and terminals 106, 108, and 110.

The network 102 may be a wired or wireless network. The network 102 may be, for example, a Local Area Network (LAN), a Wireless Local Area Network (WLAN), a Wide Area Network (WAN), a Metropolitan Area Network (MAN), or a Systems Area Network (SAN). The network 102 may be or may provide access to the Internet. The network 102 may include, for example, databases, servers, the Internet cloud, but is not limited thereto.

Each of the terminals 106, 108, and 110 may be operated by a user and may be connected to the network 102. The terminals 106, 108, and 110 may include, for example, a mobile phone, a smart phone, an electronic pad, a laptop, a computer, and a smart television. In general, the terminals 106, 108, and 110 may be any suitable electronic device capable of connecting to the network 102. The terminals 106, 108, and 110 may include hardware and/or software. For example, the terminals 106, 108, and 110 may have any suitable operating system and/or software that enable the terminals 106, 108, and 110 to connect to network 102 and to perform various operations (e.g., telephone call, display of image, image capture, botnet detection, etc). The terminals 106, 108, and 110 may also include various hardware including, but not limited to, a processor, storage device, transceivers, display unit, decoders, etc, to perform various operations desired by a user. For example, the terminal 106 may transceive a signal to gateway 104 using an antenna, and the transceived signal may be processed using any combination of software and/or hardware.

The gateway 104 may provide a connection between the network 102 and any one of terminals 106, 108, and 110. In some cases, the gateway 104 may be a server or proxy server, and, in some cases, the gateway 104 may include firewall functionality. The gateway 104 may control data transmitted between network 102 and terminals 106, 108, and 110, and may allow or prevent, using a predetermined criteria, data being sent between terminals 106, 108, and 110 and network 102. The gateway 104 may be connected, in a wired or wireless manner, to terminals 106, 108, and/or 110 and one or more networks, including network 102. In some cases, the gateway 104 may include router functionality and may determine how to route data packets transmitted between the network 102 and terminals 106, 108, and/or 110. For example, the gateway 104 may include network address translation (NAT) tables and various other suitable database and tables to route packets through the gateway 104.

The gateway 104 may include hardware and/or software. For example, the gateway 104 may have any software to perform various operations (e.g., firewall, routing, protocol conversions, botnet detection), and to facilitate connectivity between the terminals 106, 108, and 110 and network 102. The gateway 104 may also include various hardware including, but not limited to, a processor, storage device, transceivers, display unit, decoders, etc, to perform various operations.

The communications system 100 may include a botnet detection system having one or more botnet detectors 200. For example, at least one of the gateway 104 and terminals 106, 108, and 110 may include a botnet detector 200 to detect various types of botnets. The botnet detector 200 may use various suitable detection methods to detect botnets, including, using a Bayesian framework to detect botnets. For example, the botnet detector 200 may use formal inference of a Bayesian network to detect botnets.

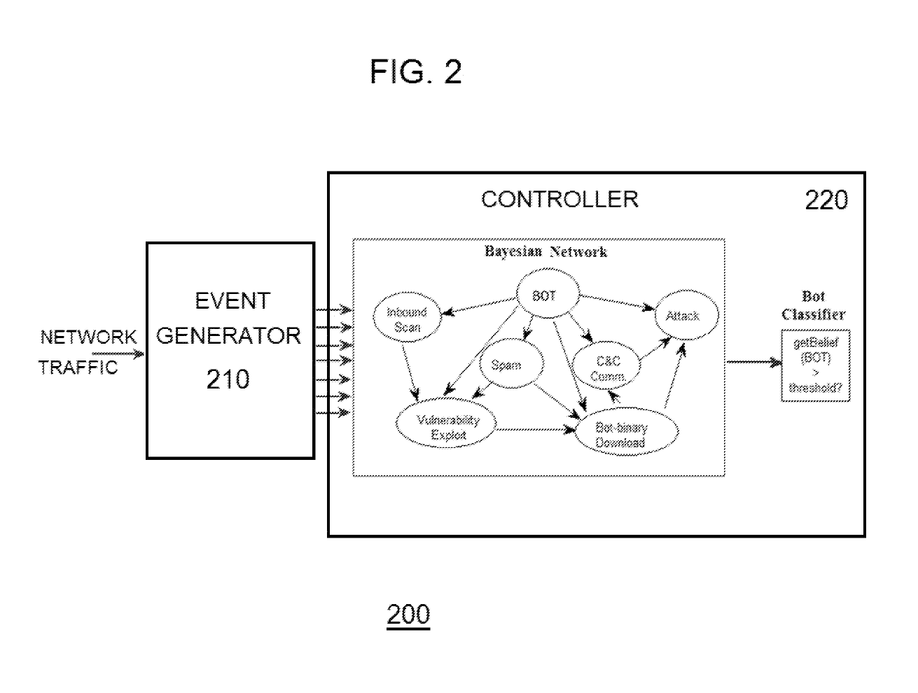

FIG. 2 is a block diagram of a botnet detector 200 according to exemplary embodiments of the disclosed subject matter.

The botnet detector 200 may include various components including, but not limited to, an event generator 210 and a controller 220. The botnet detector 200 may operate in various modes, including, but not limited to, a training mode, an evaluation mode, and an action mode. The event generator 210 and the controller 220 may be any combination of hardware and/or software configured to perform the operations of the botnet detector 200 as described hereinbelow. For example, in some cases, the controller 220 may include a processor to receive, process, and classify data. In some cases, the event generator 210 may include a detection module for detecting events. In some cases, the event generator 210 may include a receiver for receiving data.

The botnet detector 200 may be implemented in at least one of the gateway 104 and terminals 106, 108, and 110. In the exemplary embodiments described hereinbelow, if a botnet detector 200 is implemented in any one of terminals 106, 108, and 110, network data received by the event generator 210 of the botnet detector 200 may refer to data provided from network 102 via gateway 104. If a botnet detector 200 is implemented in gateway 104, network data received by the event generator 210 of the botnet detector 200 may refer to data received from network 102.

The event generator 210 may receive network data/traffic and may detect events corresponding to events in a bot lifecycle in a training mode and/or an evaluation mode. After detecting the events, the event generator 210 may generate a file that may include, but is not limited to, one or more of information associated with the event, an evaluation time period, and labels of each host. The file may be transmitted to the controller 220. A host may be any device or module from which the network data is determined to be received. The evaluation time period may be set by a user or system administrator according to a criterion. For instance, the evaluation time period may be set for a determined time period to obtain optimal true positive rates and false positive rates. In some cases, the evaluation time period may be in a range of about 5 minutes to about 30 minutes. If the evaluation time period is less than about 5 minutes, the botnet detector 200 may have a less than about 91.7% true positive rate. If the evaluation time period is greater than about 30 minutes, the true positive rate does not change substantively; therefore, an evaluation time period of greater than about 30 minutes may not be needed and further resources needed for an evaluation time period of greater than about 30 minutes may not be consumed. The botnet detector 200 may include an input unit (not shown) to receive an input, for example, from a user or system administrator, to modify or set the evaluation time period.

The controller 220 may execute a Bayesian learning process in a training mode and a Bayesian inference process in an evaluation mode. The controller 220 may generate a Bayesian network model, and may adjust the Bayesian network model based on the Bayesian learning process. For example, conditional probabilities between nodes in the Bayesian network model may be modified based on the information provided by the file generated by the event generator 210.

FIG. 2 illustrates an example of a Bayesian network model. It should be understood that various suitable models may be used as the Bayesian network model. In some cases, the Bayesian network model may correspond to a bot lifecycle model. A structure of a bot lifecycle may have minimal changes over time and therefore the bot lifecycle provides a reliable model for botnet detection. The Bayesian network model illustrated in FIG. 2 includes a plurality of nodes. The plurality of nodes may include one or more hypothesis nodes and one or more evidence nodes. The evidence nodes may correspond to an event in a bot lifecycle.

In FIG. 2, the Bayesian network model may include, but is not limited to, an Inbound Scan node, a Vulnerability Exploit node, a Spam node, a Bot-binary Download node, a C&C Communication (Comm.) node, an Attack node, and a BOT node. The BOT node may be a hypothesis node, and the Inbound Scan node, Vulnerability Exploit node, Spam node, Bot-binary Download node, C&C Communication (Comm.) node, Attack node may be evidence nodes.

The Inbound Scan node may correspond to an event associated with an inbound scan, which in a Bayesian network, may refer to a vertical scan being performed at a terminal (e.g., host). In some cases, the Inbound Scan may be the first step in a bot infection.

The Spam node may correspond to an event associated with Spam, which in a Bayesian network, may be an alternate entry-point for malicious bot binaries into a terminal (e.g., host). Spam can be received in various ways, for example, through electronic mail (e-mail) or through social networks posts/tweets. In some cases, bots may actively send their own binaries as spam links as a means of self-propagation. In some cases, affiliate programs bundle bot binaries with legitimate software in exchange for a fee.

The Vulnerability Exploit node may correspond to an event associated with exploitation of a terminal (e.g., host). Inbound scan or spam may lead to a terminal being exploited, which may allow a remote attacker to run its own code on the terminal (e.g., host) without the terminal user's knowledge.

The Bot-binary Download node may correspond to an event associated with a malicious binary (“egg”) being downloaded onto a terminal (e.g., host). The egg may be downloaded after a vulnerability exploit or a spam link is followed. The egg is a bot binary that may represent an actual infection and may contain instructions for connecting to a command and control server, for downloading additional components or updates, or for performing attack or information-capture functions.

The C&C Comm. node may correspond to an event representing a host communicating with a botnet command and control (CNC) server (e.g., blacklisted server). The C&C Comm. node may be a node following the Bot-binary Download node in a bot lifecycle. Communication of a host with its botnet CNC server may be detected using an Internet Protocol (IP) address of the host or by tracking Domain Name System/Server (DNS) failures.

The Attack node may correspond to an event representing propagation of an attack by a bot. Various types of attacks, including but not limited to, denial of service (DOS) attacks and sending spam, may correspond to this event. The event representing propagation of an attack may occur after a bot binary communicates with its CNC severs to receive instructions.

The Bot Node, as noted above, is a hypothesis node, not an evidence node. Accordingly, the Bot node is not a lifecycle event. Instead, the Bot node is a node representing what is to be inferred from the other lifecycle events. A probability value of the Bot node may be calculated depending on the known values associated with the other nodes in the Bayesian network model. Other nodes in the Bayesian network model are known to be either true or false (i.e., these lifecycle events have either occurred or not occurred for an observed host), and the Bot node gets a probability value representing how likely a host is a Bot given the lifecycle event(s) combination observed.

Based on the execution of the Bayesian learning process in a training mode and the Bayesian inference process in an evaluation mode, the controller 220 may calculate or determine the probability that a host identified by a generated file is a bot. The controller 220 may determine that the identified host is a bot if the calculated probability or confidence value associated with the identified host is greater than a threshold. The threshold may be adjusted based on a desired accuracy. In general, the threshold may be set at a relatively high value to provide greater accuracy. The controller 220 may also obtain utility values. Based on the obtained utility values, the controller 220 may perform an action affecting data received from a host identified by the generated file.

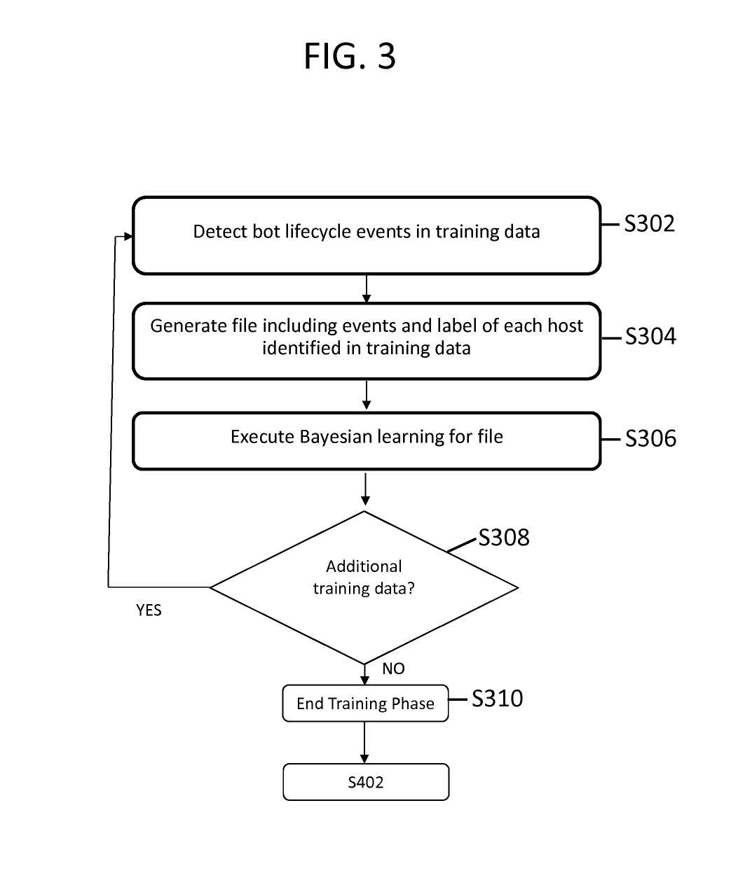

The training mode of the botnet detector 200 will be described with reference to FIG. 3. FIG. 3 is a diagram of the training mode of the botnet detector 200 according to exemplary embodiments of the present disclosure.

The event generator 210 may receive training data and may detect bot lifecycle events in the training data (S302). The training data may include data labeled or determined to be malicious or benign. The event generator 210 may then generate a file including the detected events and labels of each host identified by the training data (S304). The controller 220 may receive the generated file and execute Bayesian learning based on the input file (S306). The controller 220 may use the information acquired through Bayesian learning to generate/adjust a Bayesian network model. Accordingly, the controller 220 may be trained using the information acquired through Bayesian learning. For example, probabilities associated with nodes in the Bayesian network model may be modified and/or determined based on the Bayesian learning. After executing the Bayesian learning, the controller 220 may determine whether additional training data for training purposes remain (S308). If additional training data and/or generated files for training purposes remain, the training mode repeats itself, and the event generator 210 may detect bot lifecycle events in the training data (S302). If no additional training data for training purposes remain, the training mode ends (S310). After the training mode ends, the botnet detector 200 may, in some cases, operate in the evaluation mode.

The Bayesian network model may initially be configured using initial conditional probabilities obtained from a data trace. The initial conditional probabilities are then subsequently updated through the Bayesian learning process using the files generated by the event generator 210.

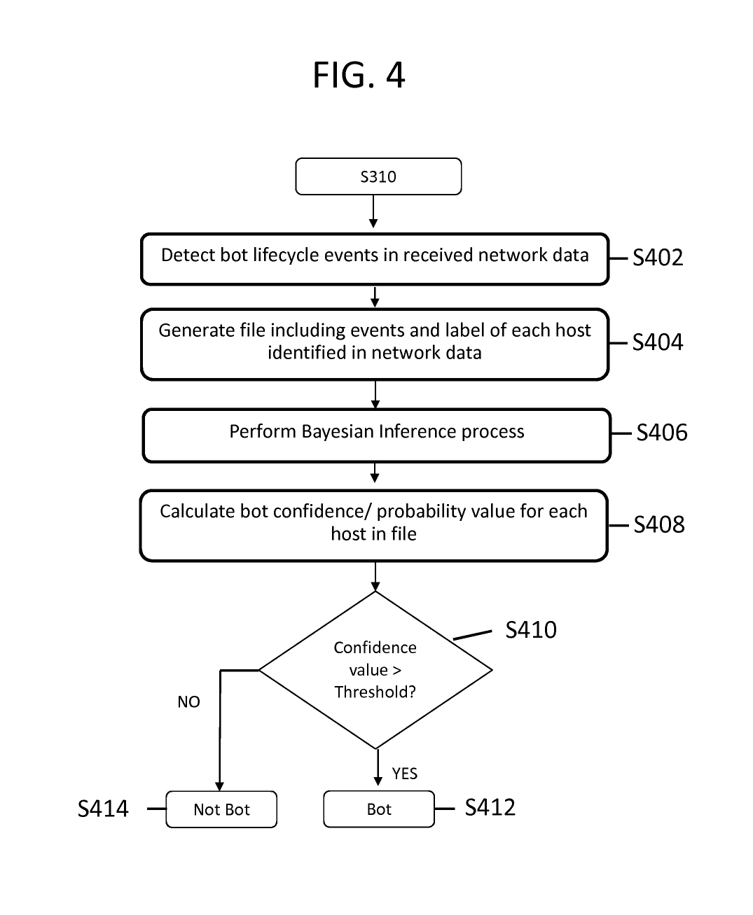

The evaluation mode of the botnet detector 200 will be described with reference to FIG. 4. FIG. 4 is a diagram of the evaluation mode of the botnet detector 200 according to exemplary embodiments of the disclosed subject matter.

The event generator 210 may receive network data/traffic and may detect bot lifecycle events (S402). The event generator 210 may then generate a file including the detected bot lifecycle events for each host identified in the network data (S404). The controller 220 may receive the generated file from the event generator 210 and perform a Bayesian inference process (S406). To perform the Bayesian inference process, the controller 220 may compare the received file with the trained Bayesian network model to classify the network data. After performing the Bayesian inference process, the controller 220 may update belief values for nodes in the Bayesian network and may calculate a bot confidence value for each host identified in the generated file (S408). In some cases, the confidence value may be a calculated probability of a host being associated with a botnet. In general, the confidence value may be any value providing information on whether a host is associated with a bot. The controller 220 may compare the confidence value with a threshold value (S410). If the confidence value is greater than the threshold value, the controller 220 may determine that at least one host identified in the file is a bot (S412). If the confidence value is less than or equal to the threshold value, the controller may determine that a corresponding host is not a bot (S414). The threshold value may be selected to ensure the highest accuracy based on true and false positive rates and true and false negative rates. For example, in some cases, the threshold value may be set to about 0.6. If the threshold value is greater than about 0.6, the true positive rates may decline and the false negative rates may increase. If the threshold value is less than about 0.6, the false positive rates may increase and the true negative rates may decrease.

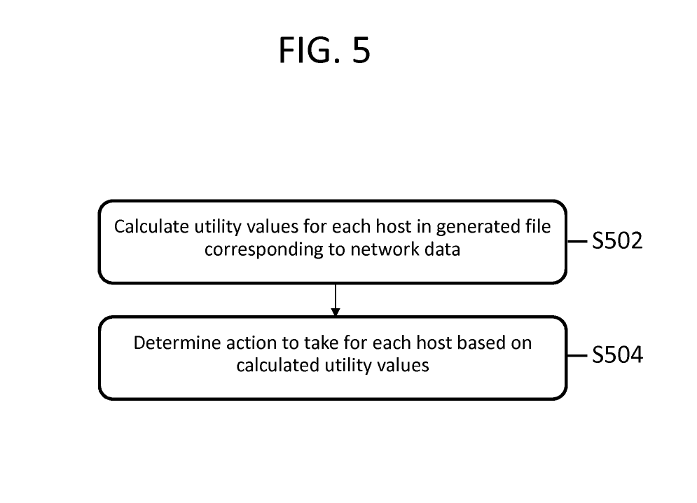

After completing the evaluation mode, the botnet detector 200 may, in some cases, operate in the action mode. In some cases, the action mode may be performed by the botnet detector 200 before operation of the evaluation mode is completed. The action mode of the botnet detector 200 will be described with reference to FIG. 5. FIG. 5 is a diagram of the action mode of the botnet detector 200 according to exemplary embodiments of the disclosed subject matter.

In the action mode, the controller 220 may obtain a utility policy and the confidence values calculated in the evaluation mode (S502). The botnet detector 200 may have a storage unit (not shown) for storing various policies and rules. The policies may include, for example, the utility policy that includes a utility table. The utility policy may be provided by a systems or network administrator, and may be obtained by the controller 220 from the storage unit. The controller 220 may then compare calculated confidence values corresponding to a host to utility values in the utility table, and determine which action to take (S504). After determining the action, the controller 220 may perform the action (S506). The actions may include at least one of a blocking action, an alarm action, or an allowance action. The blocking action may include blocking data to be transmitted to or received from a host. The alarm action may include generating a report regarding a host and sending the report to a network administrator. The allowance action may include allowing data to be transmitted to or received from a host. The actions performed may depend on how conservative or liberal the utility policy is. For example, in some cases, if the utility policy is conservative, utility values corresponding to a blocking action or an alarm action may be high positive values. Accordingly, in a conservative utility policy, a blocking action or an alarm action is more likely to be performed if the calculated confidence values are low. In some cases, if the utility policy is liberal, utility values corresponding to a blocking action or an alarm action may be lower positive values. Accordingly, in a liberal utility policy, a blocking action or an alarm action is less likely (compared to a conservative utility policy) to be performed if the calculated confidence values are low. In general, it should be understood that the utilities with high positive values, high negative values, and low negative and positive values may be variably set by a user, systems administrator, or network administrator.

As can be appreciated from the foregoing, according to exemplary embodiments of the disclosure, a botnet detection system and method are provided that do not use rigid rules and that provide a high accuracy for botnet detection. Another advantage of the disclosed botnet detection system and method is that the method and system may be implemented in an on-line mode or offline mode. In an offline mode, data may be collected offline, and the method to detect botnets may be executed. Large volumes of non-real time data may be processed in the offline mode. In the on-line mode, the method to detect botnets may be performed on real-time data using, for example, evaluation time periods of 5 minutes as explained in exemplary embodiments of the present disclosure above. Accordingly, a controller 220 may determine a Bayesian network model in at least one of the offline mode and the on-line mode. As can be appreciated from the foregoing, the present disclosure provides a botnet detection system and method that may be effectively utilized on-line or offline, and provides a high degree of accuracy without using rigid rules and heuristic models in an ad-hoc manner.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

It should be appreciated that exemplary embodiments of the disclosed subject matter may be implemented by a computer-readable medium encoded with one or more programs including instructions that, when executed on one or more computers or other processors, perform methods or acts that implement the various exemplary embodiments of the disclosed subject matter. The computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. In some cases, the computer-readable media may be electronic media, electromagnetic media, infrared, or other communication media such as carrier waves. Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed above.

It will be apparent to those skilled in the art that various modifications and variations can be made in the present disclosure without departing from the spirit or scope of the disclosed subject matter. Thus, it is intended that the present disclosure cover the modifications and variations of the disclosed subject matter provided they come within the scope of the appended claims and their equivalents.

What is claimed is:

1. An apparatus, comprising:
an event generator configured to detect at least one event in received data, and to provide information associated with the at least one event; and
a controller configured to receive the information associated with the at least one event, to determine, using a Bayesian learning process, a Bayesian network model based on the information associated with the at least one event, and to determine whether at least one host associated with the received data corresponds to a bot.

2. The apparatus of claim 1, wherein an evaluation time period associated with the Bayesian network model is configured at a time period ranging from about 5 minutes to about 30 minutes.

3. The apparatus of claim 1, wherein the controller is configured to determine a confidence value associated with the at least one host.

4. The apparatus of claim 3, wherein the controller is configured to determine whether the at least one host associated with the received data corresponds to a bot by comparing the confidence value with a threshold.

5. The apparatus of claim 3, wherein the controller is configured to compare the confidence value with at least one utility value in a utility table.

6. The apparatus of claim 5, wherein the controller is further configured to allow or block data from the at least one host based on the comparison.

7. The apparatus of claim 1, wherein the controller is configured to determine whether the at least one host associated with the received data corresponds to a bot based on a Bayesian inference process.

8. The apparatus of claim 1, wherein the Bayesian network model comprises a bot lifecycle model.

9. The apparatus of claim 1, wherein the controller is configured to determine a Bayesian network model in an offline mode and an on-line mode.

10. A method for botnet detection, the method comprising:
receiving data from at least one host;
detecting at least one event in the received data;
providing information associated with the at least one event;
determining, using a Bayesian learning process, a Bayesian network model based on the information associated with the at least one event; and
determining whether the at least one host associated corresponds to a bot.

11. The method of claim 10, further comprising setting an evaluation time period associated with the Bayesian network model at a time period ranging from about 5 minutes to about 30 minutes.

12. The method of claim 10, further comprising determining a confidence value associated with the at least one host.

13. The method of claim 12, wherein determining whether the at least one host associated with the received data corresponds to a bot comprises comparing the confidence value with a threshold.

14. The method of claim 12, further comprising comparing the confidence value with at least one utility value in a utility table.

15. The method of claim 14, further comprising allowing or blocking data from the at least one host based on the comparing.

16. The method of claim 10, wherein determining whether the at least one host associated corresponds to a bot comprises using a Bayesian inference process to determine whether the at least one host associated corresponds to a bot.

17. The method of claim 10, wherein determining the Bayesian network model comprises determining the Bayesian network model in an offline mode and an on-line mode.

18. One or more non-transitory computer-readable storage media having stored thereon a computer program that, when executed by one or more processors, causes the one or more processors to perform acts comprising:
receiving data from at least one host;
detecting at least one event in the received data;
providing information associated with the at least one event;
determining, using a Bayesian learning process, a Bayesian network model based on the information associated with the at least one event; and
determining whether the at least one host associated corresponds to a bot.

19. The one or more non-transitory computer-readable storage media of claim 18, further causing the one or more processors to perform an act comprising:
setting an evaluation time period associated with the Bayesian network model at a time period ranging from about 5 minutes to about 30 minutes.

20. The one or more non-transitory computer-readable storage media of claim 18, wherein determining the Bayesian network model comprises determining the Bayesian network model in an offline mode and an on-line mode.
